(19) United States
(12) Patent Application Publication
(10) Pub. No.: US 2022/0097993 A1
(43) Pub. Date: Mar. 31, 2022

(54) METHOD FOR MANUFACTURING CYLINDRICAL MEMBER, CYLINDRICAL MEMBER, AND IMAGE FORMING APPARATUS

(71) Applicant: FUJIFILM Business Innovation Corp., Tokyo (JP)

(72) Inventors: Toshiaki BABA, Kanagawa (JP); Tomoaki Yoshioka, Kanagawa (JP); Yoko Miyamoto, Kanagawa (JP); Kazuki Kishi, Kanagawa (JP); Yosuke Tsutsumi, Kanagawa (JP)

(73) Assignee: FUJIFILM Business Innovation Corp., Tokyo (JP)

(21) Appl. No.: 17/326,522

(22) Filed: May 21, 2021

(30) Foreign Application Priority Data
Sep. 30, 2020 (JP) 2020-166251

(51) Int. Cl. B65H 27/00

(52) U.S. Cl. CPC B65H 27/00; B65H 2801/03; B65H 2404/1141; B65H 2404/1118

(57) ABSTRACT

A method for manufacturing a cylindrical member includes: fixing an end portion of an elastic body to an end portion, in a circumferential direction, of a recess provided in a cylindrical body having a substantially circular shape in cross section, the recess extending along an axial direction of the cylindrical body; and winding the elastic body around the cylindrical body while pressing the elastic body using a pressing member.

### CROSS-REFERENCE TO RELATED APPLICATIONS

This application is based on and claims priority under 35 USC 119 from Japanese Patent Application No. 2020-166251 filed Sep. 30, 2020.

### BACKGROUND

### (i) Technical Field

The present disclosure relates to a method for manufacturing a cylindrical member, a cylindrical member, and an image forming apparatus.

### (ii) Related Art

The following transfer device has been know. That is, the transfer device includes a transport unit and a gripper piece. The transport unit moves a transfer material along a circulation movement path. The gripper piece is attached to the transport unit. The gripper piece is supported by a rotation shaft so as to rotate with respect to a base member and to grip a leading side of the transfer material. The transfer device transfers an image on an image carrier onto the transfer material (for example, see JP-A-58-005769).

### SUMMARY

Aspects of non-limiting embodiments of the present disclosure relate to, when a cylindrical member including a cylindrical body around which an elastic member is wound rotates while a rotating member is pressing the cylindrical member, making it difficult to displace the elastic member with respect to a cylindrical body as compared to a case in which the elastic body is wound around the cylindrical body without a pressure applied to the elastic body.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a method for manufacturing a cylindrical member, the method including: fixing an end portion of an elastic body to an end portion, in a circumferential direction, of a recess provided in a cylindrical body having a substantially circular shape in cross section, the recess extending along an axial direction of the cylindrical body; and winding the elastic body around the cylindrical body while pressing the elastic body using a pressing member.

### BRIEF DESCRIPTION OF THE DRAWINGS

Exemplary embodiment(s) of the present disclosure will be described in detail based on the following figures, wherein:

FIG. 1 is a schematic diagram showing a configuration of an image forming apparatus according to an exemplary embodiment:

FIG. 2 is a perspective view showing a configuration of a transfer body according to the exemplary embodiment;

FIG. 3 is a perspective view showing a configuration of a fixing device according to the exemplary embodiment:

FIG. 4 is a perspective view showing grippers according to the exemplary embodiment:

FIG. 5 is a cross-sectional view showing a configuration of a transfer cylinder according to the exemplary embodiment:

FIG. 6 is a developed view showing a transfer member according to the exemplary embodiment;

FIG. 7 is a perspective view showing a configuration of one end portion of the transfer member in a circumferential direction according to the exemplary embodiment;

FIG. 8 is a cross-sectional view showing a configuration of the one end portion of the transfer member in the circumferential direction according to the exemplary embodiment:

FIG. 9 is a perspective view showing a configuration of the other end portion of the transfer member in the circumferential direction according to the exemplary embodiment:

FIG. 10 is a cross-sectional view showing a configuration of the other end portion of the transfer member in the circumferential direction according to the present exemplary embodiment:

FIG. 11 is a cross-sectional view showing an initial stage of a winding step of winding the transfer member around a cylindrical body while pressing the transfer member using a pressure roller according to the exemplary embodiment;

FIG. 12 is a cross-sectional view showing an intermediate stage of the winding step of winding the transfer member around the cylindrical body while pressing the transfer member using the pressure roller according to the exemplary embodiment;

FIG. 13 is a cross-sectional view showing a late stage of the winding step of winding the transfer member around the cylindrical body while pressing the transfer member using the pressure roller according to the exemplary embodiment; and

FIG. 14 is a schematic diagram showing a configuration of another image forming apparatus according to the exemplary embodiment.

### DETAILED DESCRIPTION

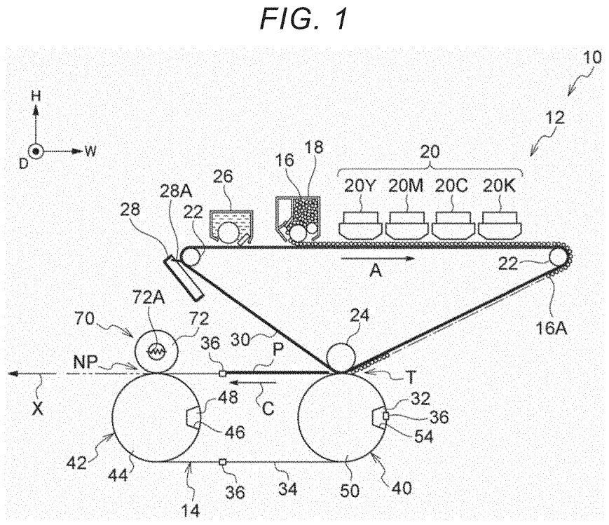

Hereinafter, an exemplary embodiment of the present disclosure will be described in detail based on the accompanying drawings. For the convenience of description, a direction along an arrow H illustrated in FIG. 1 will be referred to as an up and down direction of an image forming apparatus 10, a direction along an arrow W will be referred to as a width direction of the image forming apparatus 10, and a direction along an arrow D will be referred to as a front to rear direction (or a depth direction) of the image forming apparatus 10.

As illustrated in FIG. 1, the image forming apparatus 10 is, for example, an inkjet apparatus that forms an ink image (an example of an image) on a recording medium P. The image forming apparatus 10 includes an image forming unit 12, a transport unit 14, and a fixing device 70 in an apparatus body (not illustrated).

Hereinafter, the respective units of the image forming apparatus 10 (that is, the image forming unit 12, the transport unit 14, and the fixing device 70) will be described, followed by a description on (i) a transfer cylinder 50 (an example of a cylindrical member) and (ii) a method for manufacturing the transfer cylinder 50 will be described.

### Image Forming Unit

The image forming unit 12 has a function of forming the ink image on the recording medium P. Specifically, the image forming unit 12 includes a transfer belt 30 (an example of an intermediate transfer body), plural rollers 22 (in this exemplary embodiment, two rollers 22), an opposing roller 24 (an example of a rotating member), an adhesive layer forming device 26, a particle supply device 18, an ejection head 20, a transfer body 40, and a cleaner 28.

The transfer belt 30 is formed in an endless shape. The transfer belt 30 is wound on the two rollers 22 and the opposing roller 24 so as to have a posture of an inverted triangle shape when viewed from the apparatus depth direction. At least one roller of the two rollers 22 is driven to rotate, so that the transfer belt 30 rotates and moves in a direction indicated by an arrow A.

The adhesive layer forming device 26, the particle supply device 18, the ejection head 20, the transfer body 40, and the cleaner 28 are arranged on an outer circumferential surface side of the transfer belt 30 in this order from an upstream side in a direction in which the transfer belt 30 rotates (hereinafter referred to as a “belt rotation direction”).

The adhesive layer forming device 26 is disposed at an end portion on one side (specifically, an end portion on a left side in FIG. 1), in the apparatus width direction, of a horizontal portion of the transfer belt 30 having the posture of the inverted triangle shape. The adhesive layer forming device 26 accommodates an adhesive agent therein. The adhesive layer forming device 26 applies the adhesive agent to the outer circumferential surface of the transfer belt 30, which is rotating and moving, so as to form an adhesive layer (not illustrated). Examples of the adhesive agent include glue and an organic solvent.

The particle supply device 18 is disposed in the horizontal portion of the transfer belt 30 and downstream (specifically, on a right side in FIG. 1), in the belt rotation direction, of the adhesive layer forming device 26. The particle supply device 18 accommodates ink receptive particles 16 that readily accept ink droplets. The particle supply device 18 supplies the ink acceptable particles 16 onto the transfer belt 30 on which the adhesive layer has been formed.

That is, the ink receptive particles 16 supplied by the particle supply device 18 onto the transfer belt 30 are caused to adhere to the adhesive layer by an adhering force of the adhesive layer, so as to form an ink receptive particle layer 16A on the transfer belt 30.

The ejection head 20 is disposed in the horizontal portion of the transfer belt 30 and on downstream (specifically, on the right side in FIG. 1), in the belt rotation direction, of the particle supply device 18. The plural ejection heads 20 are provided so as to form ink images of respective colors. In the present exemplary embodiment, the ejection heads 20 of four colors, that is, yellow (Y), magenta (M), cyan (C), and black (K) are provided. In FIG. 1, suffixes “Y”, “M”, “C”, and “K” are added after the reference numeral “20”, so as to correspond to such colors.

The ejection head 20 of each color ejects ink droplets from nozzles (not illustrated) to the ink receptive particle layer 16A using a known technique such as a thermal method or a piezoelectric method, so as to form the ink image based on image data. That is, the ink droplets ejected from the ejection head 20 of each color are accepted by the ink receptive particle layer 16A, so as to form the ink image.

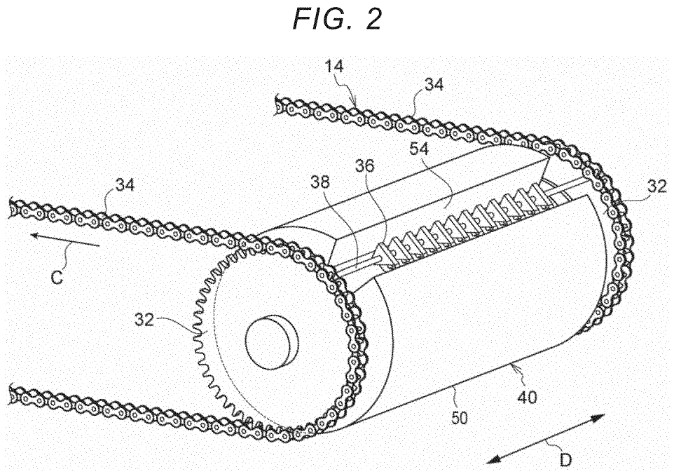

The transfer body 40 is disposed below the transfer belt 30. As illustrated in FIG. 2, the transfer body 40 includes the transfer cylinder 50 that is disposed such that an axial direction of the transfer cylinder 50 is the same as an axial direction of the opposing roller 24. The transfer cylinder 50 is disposed opposing the transfer belt 30. The transfer cylinder 50 forms a nip region T in which the transfer cylinder 50 and the opposing roller 24 nip the transfer belt 30 (see FIG. 1).

In the present exemplary embodiment, as the transfer belt 30 rotates and moves, the ink image formed in the ink receptive particle layer 16A is transported to the nip region T. and the recording medium P is transported to the nip region T by the transport unit 14. Then, the transfer cylinder 50 nips the recording medium P and the ink image, which are transported to the nip region T, with the transfer belt 30 and presses the recording medium P and the ink image so as to transfer the ink image onto the recording medium P.

In FIG. 1, a transport direction of the recording medium P is indicated by an arrow X. When the transfer cylinder 50 nips the recording medium P and the ink image in the nip region T with the transfer belt 30 and presses the recording medium P and the ink image, the transfer cylinder 50 may heat the recording medium P and the ink image. A recess 54 is formed in a part of an outer circumferential surface of the transfer cylinder 50 (specifically, a transfer cylindrical body 52 which will be described later). The recess 54 is configured to accommodate grippers 36 and a support member 38 (both of which will be described later).

As illustrated in FIG. 2, a pair of sprockets 32 is provided on both end portions, in the axial direction, of the transfer cylinder 50. The pair of sprockets 32 is coaxial with the transfer cylinder 50 and rotates integrally with the transfer cylinder 50. Then, the transfer body 40 (specifically, the transfer cylinder 50) is driven to rotate by a drive unit (not illustrated). A chain 34 (which will be described later) is wound on each sprocket 32.

As illustrated in FIG. 1, the cleaner 28 is disposed downstream, in the belt rotation direction, of the nip region T and upstream, in the belt rotation direction, of the adhesive layer forming device 26. The cleaner 28 includes a blade 28A that is in contact with the outer circumferential surface of the transfer belt 30. As the transfer belt 30 rotates and moves, the cleaner 28 removes residues that have passed the nip region T and still remain on the transfer belt 30, with the blade 28A. The residues include the adhesive layer, the ink receptive particles 16, the ink, and/or other foreign matter (for example, paper dust when the recording medium P is paper).

### Fixing Device

As illustrated in FIG. 1, the fixing device 70 is a device that fixes the ink image, which has been transferred onto the recording medium P, to the recording medium P. Specifically, the fixing device 70 includes a pressurizing body 42 and a heating roller 72. The pressurizing body 42 is disposed downstream in the transport direction of the recording medium P, in the transport unit 14.

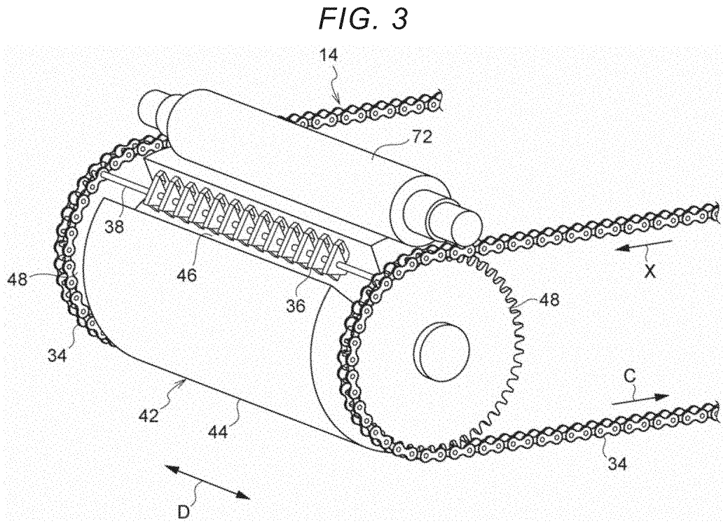

As illustrated in FIG. 3, the pressurizing body 42 includes a pressure roller 44 disposed such that an axial direction of the pressure roller 44 is the same as the axial direction of the transfer cylinder 50. A pair of sprockets 48 is disposed on both end portions, in the axial direction, of the pressure roller 44. The pair of sprockets 48 is coaxial with the pressure roller 44 and rotates integrally with the pressure roller 44. The chain 34 (which w % ill be described later) is wound on each sprocket 48.

As illustrated in FIG. 1, the heating roller 72 and the pressure roller 44 are arranged in the height direction. That is, the heating roller 72 is disposed above the pressure roller 44. The heating roller 72 includes a heat source 72A such as a halogen lamp therein (see FIG. 1). Hereinafter, a position where the heating roller 72 and the pressure roller 44 nip the recording medium P will be referred to as a “nip position NP”.

A moving mechanism including a cam enables the heating roller 72 to move between (i) a contact position where the heating roller 72 is in contact with the pressure roller 44 and (ii) a separation position where the heating roller 72 is separated from the pressure roller 44. Specifically, the heating roller 72 is always pressed or pulled toward the contact position by an elastic force of, for example, an elastic member (such as a spring). The moving mechanism moves the heating roller 72 to the separation position against such an elastic force. At the contact position, the heating roller 72 nips the recording medium P with the pressure roller 44.

In the present exemplary embodiment, the heating roller 72 is driven to rotate, and the pressure roller 44 is rotated along with the rotation of the heating roller 72. Alternatively, both the heating roller 72 and the pressure roller 44 may be driven to rotate. A recess 46 is formed in a part of an outer circumferential surface of the pressure roller 44. The recess 46 is configured to accommodate the grippers 36 and the support member 38 (both of which will be described later).

### Transport Unit

As illustrated in FIGS. 1 to 3, the transport unit 14 has a function of transporting the recording medium P to pass through the nip region T and the nip position NP. The transport unit 14 includes the pair of chains 34 and the grippers 36. The pair of chains 34 is an example of a driving force transmission member. The grippers 36 are an example of a holding member that holds a leading end portion of the recording medium P. FIG. 1 illustrates the chains 34 and the grippers 36 in a simplified manner.

As illustrated in FIG. 1, each chain 34 is formed in an annular shape. As illustrated in FIGS. 2 and 3, the chains 34 are arranged at an interval in the apparatus depth direction. That is, the chains 34 are respectively wound on (i) the sprockets 32, which are coaxial with the transfer cylinder 50, and (ii) the sprockets 48, which are coaxial with the pressure roller 44.

Therefore, when the transfer cylinder 50 (the transfer body 40) is driven to rotate, the pressure roller 44 (pressurizing body 42) is rotated along with the rotation of the transfer cylinder 50 (the transfer body 40) through the pair of sprockets 32, the pair of chains 34, and the pair of sprockets 48. That is, a rotational driving force of the transfer cylinder 50 is transmitted to the pressure roller 44 by the pair of chains 34 which rotates and moves in a rotation direction C (see FIG. 1).

As illustrated in FIGS. 2 and 3, the support member 38 to which the grippers 36 are attached bridges between the chains 34 along the apparatus depth direction. The plural support members 38 (three support members 38 in FIG. 1) are provided. The support members 38 are arranged at predetermined intervals along a circumferential direction (that is, the rotation direction C) of the chains 34. The support members 38 are fixed to the pair of chains 34.

Also, the plural grippers 36 are arranged at a predetermined interval along the apparatus depth direction and mounted on each supporting member 38. That is, the grippers 36 are attached to the chains 34 through each supporting member 38. Then, each gripper 36 has a holding function of holding the leading end portion of the recording medium P.

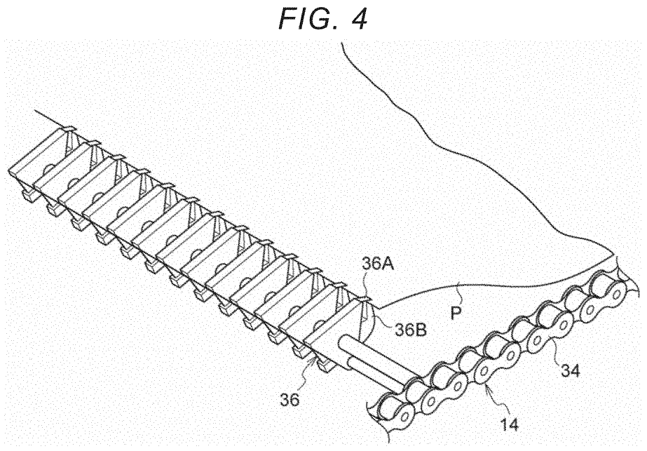

Specifically, as illustrated in FIG. 4, each gripper 36 includes a pawl 36A and a pawl base 36B. The grippers 36 hold the recording medium P by sandwiching the leading end portion of the recording medium P between the pawls 36A and the pawl bases 36B. Therefore, the grippers 36 are an example of a sandwiching unit that sandwiches the recording medium P in a thickness direction thereof.

Also, the grippers 36 which are located downstream, in the transport direction, of the recording medium P hold the leading end portion of the recording medium P from a downstream side in the transport direction of the recording medium P. Each grippers 36 is configured such that, for example, the pawl 36A is pressed against the pawl base 36B by a spring or the like, and the pawl 36A is separated from the pawl base 36B by an action of a cam or the like.

In this manner, in the transport unit 14, the grippers 36 hold the leading end portion of the recording medium P fed from an accommodating unit (not illustrated) that accommodates recording media P. Then, in the transport unit 14, the chains 34 rotate and move in the rotation direction C in a state where the grippers 36 hold the leading end portion of the recording medium P, so that the grippers 36 are moved to transport the recording medium P. and the recording medium P passes through the nip region T together with the grippers 36 while the grippers 36 are holding the recording medium P.

In a portion where the chains 34 are wound on the sprockets 32, the grippers 36 move in a rotation direction of the transfer cylinder 50 together with the transfer cylinder 50 in a state of being accommodated in the recess 54 of the transfer cylinder 50. Similarly, in a portion where the chains 34 are wound on the sprockets 48, the grippers 36 move in a rotation direction of the pressure roller 44 together with the pressure roller 44 in a state of being accommodated in the recess 46 of the pressure roller 44.

Here, in a state in which the heating roller 72 is located at the separation position, the transport unit 14 of the present exemplary embodiment transports the recording medium P toward the nip position NP while the grippers 36 are holding the leading end portion of the recording medium P. In response to the transport unit 14 transporting the recording medium P to the nip position NP, the transport unit 14 releases the holding of the leading end portion of the recording medium P.

That is, after the grippers 36 has passed through the nip position NP, the transport unit 14 releases the holding of the leading end portion of the recording medium P. At this time, the pressure roller 44 maintains a rotating state (that is, a state in which the chains 34 are rotating and moving).

A detector (specifically, a sensor) is disposed upstream, in the transport direction, of the nip position NP. An event that the recording medium P has transported to the nip position NP is detected based on a time that has elapsed since the detector detected the leading end of the recording medium P. A detection target of the detector may not be the leading end of the recording medium P, but may be the support member 38 or the grippers 36.

After (i) the grippers 36 have passed through the nip position NP and (ii) the holding of the leading end portion of the recording medium P by the gripper 36 is released, the heating roller 72 starts to move from the separation position to the contact position so as to nip the recording medium P transported to the nip position NP with the pressure roller 44. Then, in the state where the recording medium P is nipped between the heating roller 72 and the pressure roller 44, the heating roller 72 starts to rotate so as to transport the recording medium P.

The heating roller 72 may start to move from the separation position to the contact position before the holding of the leading end portion of the recording medium P by the gripper 36 is released, if the nipping of the recording medium P between the heating roller 72 and the pressure roller 44 is completed after the holding of the leading end portion of the recording medium P by the gripper 36 is released.

As described above, the fixing device 70 heats and presses the recording medium P while transporting the recording medium P in a state in which the heating roller 72 and the pressure roller 44 nip the recording medium, so that the fixing device 70 fixes the ink image, which has been transferred onto the recording medium P, to the recording medium P.

### Transfer Cylinder and Method for Manufacturing the Transfer Cylinder

Next, the transfer cylinder 50 in the image forming apparatus 10 having the configuration described above and a method for manufacturing the transfer cylinder 50 will be described. First, the transfer cylinder 50 will be described.

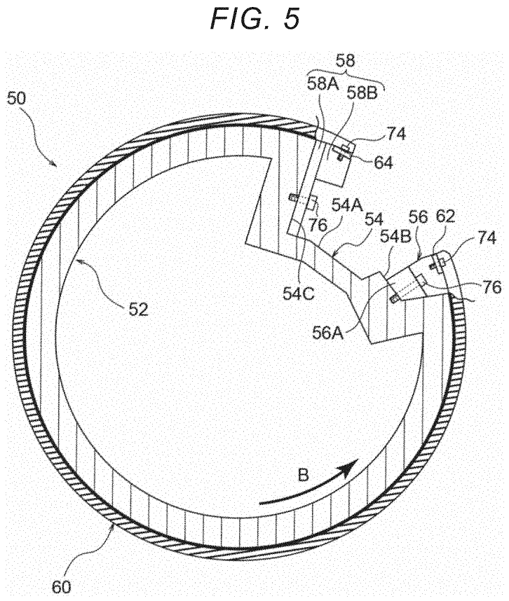

As illustrated in FIG. 5, the transfer cylinder 50 includes the transfer cylindrical body 52 (an example of a cylindrical body) and a transfer member 60 (an example of an elastic body) wound on the transfer cylindrical body 52. Hereinafter, an axial direction, a radial direction, and a circumferential direction of the transfer cylindrical body 52 (transfer cylinder 50) may be simply referred to as an “axial direction”, a “radial direction”, and a “circumferential direction”.

The transfer cylindrical body 52 is formed in a substantially cylindrical shape (substantially circular shape in cross section). The single recess 54 is formed in a part of the transfer cylindrical body 52 in the circumferential direction. The recess 54 is formed along the axial direction. The recess 54 has a depth along the radial direction of the transfer cylindrical body 52. The transfer cylindrical body 52 is made of a metal material such as stainless steel or aluminum.

A length of the transfer cylindrical body 52 along the axial direction thereof is longer than a length (that is, a width) of the transfer member 60 along the axial direction thereof. The transfer member 60 is wound on the transfer cylindrical body 52 such that a center portion of the transfer member 60 in the width direction thereof coincides with a center portion of the transfer cylindrical body 52 in the axial direction thereof. The transfer member 60 has a width larger than the maximum width of the recording medium P.

The transfer member 60 includes an elastic body having a two-layer structure having an inner peripheral layer made of foamed rubber and an outer peripheral layer made of solid rubber. The transfer member 60 is wound around an outer peripheral surface of the transfer cylindrical body 52 in a non-adhesive manner. In FIGS. 5, 8, and 10 to 13, in order to simplify the illustration, the transfer member 60 is illustrated without being divided into the two layers. A length, in the circumferential direction, of the transfer member 60 is substantially the same as a length, in the circumferential direction, of the transfer cylindrical body 52 excluding the recess 54.

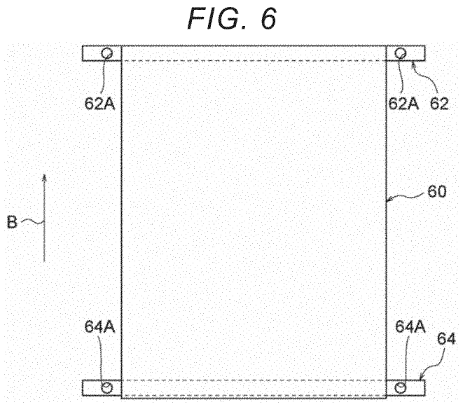

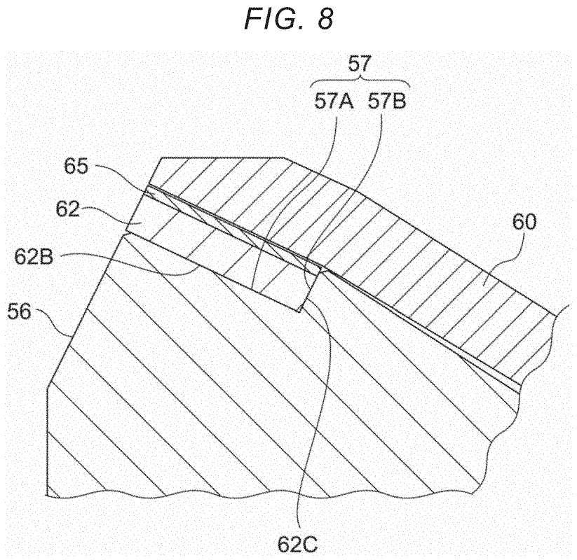

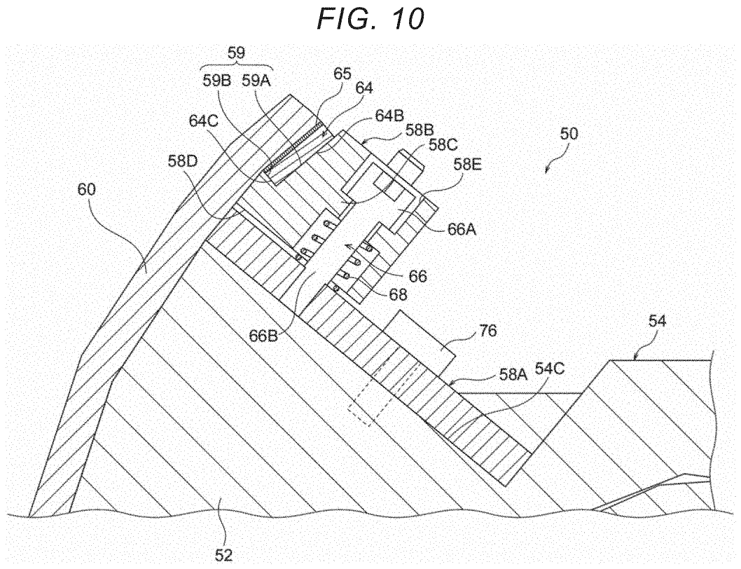

As illustrated in FIGS. 5 and 6, a first fixing member 62 and a second fixing member 64, each of which has a long and narrow flat plate shape, are attached in advance to inner peripheral surfaces of one end portion and the other end portion of the transfer member 60 in the circumferential direction with double-sided tapes 65 (see FIGS. 8 and 10). Each of the first fixing member 62 and the second fixing member 64 extends in the axial direction of the transfer cylindrical body 52. When viewed from the axial direction, each of the first fixing member 62 and the second fixing member 64 is formed in a rectangular shape such that a length of the rectangular shape along the radial direction is shorter than a length of the rectangular shape along the circumferential direction (the radial direction is the thickness direction).

The first fixing member 62 and the second fixing member 64 are each formed such that a length thereof along the axial direction of the transfer cylindrical body 52 is longer than a length (width) of the transfer member 60 along the axial direction. Each of the first fixing member 62 and the second fixing member 64 protrudes outward in the width direction of the transfer member 60 from both end portions of the transfer member 60 in the width direction thereof. The first fixing member 62 and the second fixing member 64 are each made of a metal material such as stainless steel or aluminum.

Circular through holes 62A and 64A are formed at both end portions of the first fixing member 62 and the second fixing member 64 protruding from the transfer member 60. A shaft portion of a fixing screw 74 can be inserted into each of the circular through holes 62A and 64A. That is, the inner diameter of each of the through holes 62A and 64A is larger than the outer diameter of the shaft portion of the fixing screw 74 illustrated in FIG. 5 and smaller than the outer diameter of a head portion of the fixing screw 74.

As illustrated in FIG. 5, a stepped portion 54B is formed on one side, in the circumferential direction, of a bottom wall 54A in the recess 54 of the transfer cylindrical body 52. The stepped portion 54B protrudes outward in the radial direction from the bottom wall 54A. A first fixed member 56 is provided at the stepped portion 54B. The first fixing member 62 provided at the one end portion of the transfer member 60 in the circumferential direction is attached to the first fixed member 56.

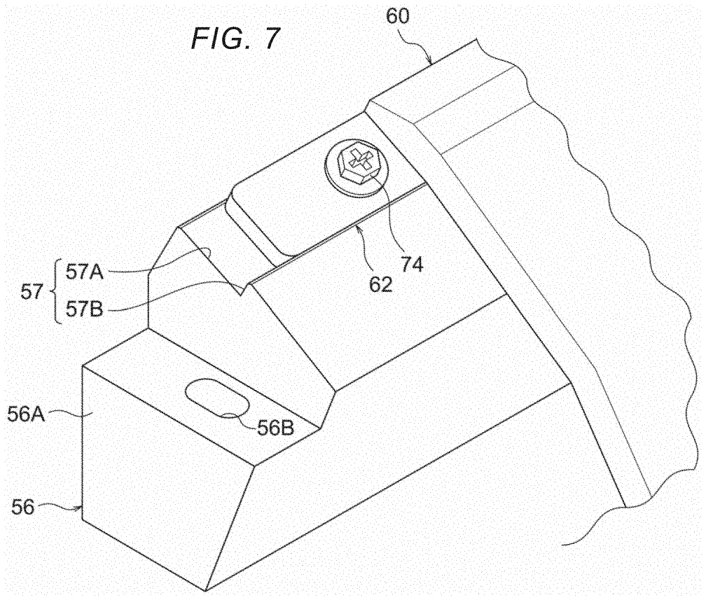

The first fixed member 56 is formed in a substantially rectangular parallelepiped shape. A longitudinal direction of the first fixed member 56 is the axial direction of the transfer cylindrical body 52. A length of the first fixed member 56 along the radial direction is longer than a length of the first fixed member 56 along the circumferential direction. Then, as shown in FIG. 7, protrusions 56A are integrally formed at radially inner portions of both axial side walls of the first fixed member 56. The protrusions 56A protrude outward in the axial direction.

The first fixed member 56 is attached to the stepped portion 54B of the transfer cylindrical body 52 by fastening the protrusion 56A thereof with a fixing screw 76 (see FIG. 5). That is, the first fixed member 56 can be detached from the stepped portion 54B of the transfer cylindrical body 52 by removing the fixing screws 76. The first fixed member 56 is detachably attached to the transfer cylindrical body 52. A through hole 56B for insertion of the fixing screw is formed in the protrusion 56A. The through hole 56B is a long hole that is elongated along the circumferential direction.

As illustrated in FIGS. 7 and 8, the first fixed member 56 includes a positioning portion 57. The positioning portion 57 positions the one end portion of the transfer member 60 in the circumferential direction with respect to the transfer cylindrical body 52 in response to the first fixing member 62 being abutted against the first fixed member 56. The positioning portion 57 includes a contact surface 57A and an abutment surface 57B. The contact surface 57A comes into contact with an inner surface 62B of the first fixing member 62 that is directed outward in the radial direction. The abutment surface 57B abuts against an end surface 62C of the first fixing member 62 that is directed to the circumferential direction.

Accordingly, the inner surface 62B of the first fixing member 62 comes into contact with the contact surface 57A and the end surface 62C of the first fixing member 62 abuts against the abutment surface 57B, so that the one end portion of the transfer member 60 in the circumferential direction is positioned with respect to the transfer cylindrical body 52.

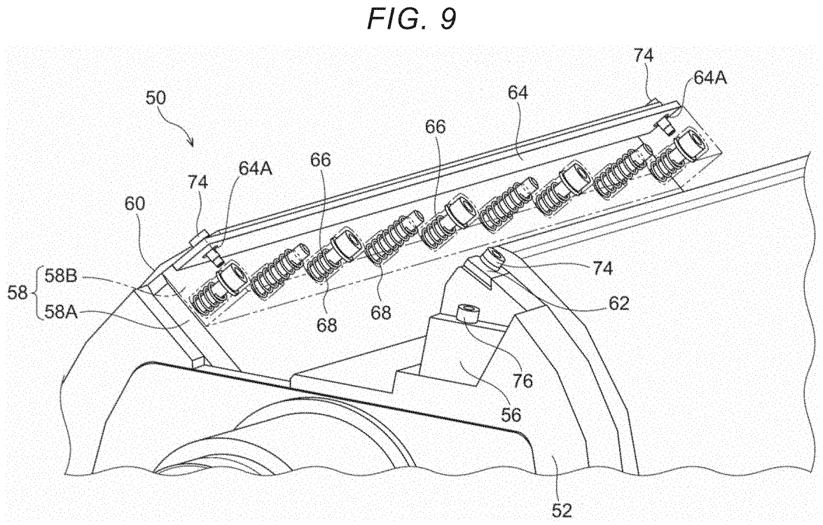

Meanwhile, as shown in FIGS. 4, 9, and 10, a second fixed member 58 is provided on the other side, in the circumferential direction, of the bottom wall 54A in the recess 54 of the transfer cylindrical body 52. The second fixing member 64 provided at the other end portion of the transfer member 60 in the circumferential direction is attached to the second fixed member 58.

The second fixed member 58 includes a plate member 58A and a moving body 58B having a rectangular parallelepiped shape. The plate member 58A is formed in a plate shape. The plate member 58A has a longitudinal direction in the axial direction of the transfer cylindrical body 52 and a thickness direction in the circumferential direction. The moving body 58B is formed in a rectangular parallelepiped shape. The moving body 58 has a longitudinal direction in the axial direction of the transfer cylindrical body 52.

The plate member 58A is fastened with the fixing screw 76, so that the second fixed member 58 is attached to a side wall 54C in the recess 54 of the transfer cylindrical body 52. That is, the second fixed member 58 can be detached from the side wall 54C of the transfer cylindrical body 52 by removing the fixing screws 76. The second fixed member 58 is detachably attached to the transfer cylindrical body 52.

The fixing screw 74 inserted into the through hole 64A of the second fixing member 64 is fastened to the moving body 58B of the second fixed member 58. As a result, both end portions of the second fixing member 64 are attached to the transfer cylindrical body 52 via the second fixed member 58. That is, the second fixing member 64 can be detached from the second fixed member 58 by removing the fixing screws 74. The second fixing member 64 is detachably attached to the transfer cylindrical body 52 via the second fixed member 58.

As illustrated in FIG. 10, the second fixed member 58 includes a positioning portion 59. The positioning portion 59 positions the other end portion of the transfer member 60 in the circumferential direction with respect to the transfer cylindrical body 52 in response to the second fixing member 64 being abutted against the second fixed member 58. The positioning portion 59 includes a contact surface 59A and an abutment surface 59B. The contact surface 59A comes into contact with an inner surface 64B of the second fixing member 64 that is directed outward in the radial direction. The abutment surface 59B abuts against an end surface 64C of the second fixing member 64 that is directed to the circumferential direction.

Accordingly, the inner surface 64B of the second fixing member 64 comes into contact with the contact surface 59A and the end surface 64C of the second fixing member 64 abuts against the abutment surface 59B, so that the other end portion of the transfer member 60 in the circumferential direction is positioned with respect to the transfer cylindrical body 52.

The plate member 58A includes plural pins 66 extending in the circumferential direction. The pin 66 has a head portion 66A and a shaft portion 66B having a smaller diameter than the head portion 66A. The pins 66 are arranged at equal intervals along the axial direction of the transfer cylindrical body 52. The moving body 58B has plural through holes 58E. The pins 66 are inserted into the through holes 58E, respectively, so that the moving body 58B is attached to the plate member 58A so as to be movable along the circumferential direction (that is, the thickness direction of the plate member 58A) via the respective pins 66.

Specifically, a compression spring 68 is fitted to the shaft portion 66B of the pin 66. One end portion of the compression spring 68 abuts against the plate member 58A. The other end portion of the compression spring 68 abuts against a flange portion 58C formed in the through hole 58E of the moving body 58B so as to protrude inward in the radial direction.

Accordingly, the moving body 58B is movable along the circumferential direction between (i) a position where the flange portion 58C abuts against the head portion 66A of the pin 66 from the shaft portion 66B side by a biasing force of the compression spring 68 and (ii) a position where an end surface 58D of the moving body 58B opposing the plate member 58A abuts against the plate member 58A against the biasing force of the compression spring 68.

With this configuration, the second fixing member 64 attached to the moving body 58B is always pulled in the circumferential direction (specifically, in a direction away from the plate member 58A) by the biasing force of the compression spring 68. As a result, tension in the circumferential direction acts on the transfer member 60 attached to the first fixed member 56 and the second fixed member 58.

As described above, the transfer member 60 is attached to the transfer cylindrical body 52 only at both end portions in the circumferential direction with the first fixing member 62 and the second fixing member 64. The transfer member 60 is not restrained with respect to the outer peripheral surface of the transfer cylindrical body 52 except for both end portions thereof in the circumferential direction attached to the transfer cylindrical body 52. Therefore, it is desirable that a friction coefficient between the outer peripheral surface of the transfer cylindrical body 52 and the inner peripheral surface of the transfer member 60 is large.

The transfer member 60 is not adhered to the outer peripheral surface of the transfer cylindrical body 52. If the friction coefficient is large, the transfer member 60 is less likely to be displaced with respect to the outer peripheral surface of the transfer cylindrical body 52, and lifting of the transfer member 60 from the outer peripheral surface is prevented. The friction coefficient is adjusted using, for example, a material selected as the transfer member 60 and surface processing performed on a contact surface with the outer peripheral surface of the transfer cylindrical body 52.

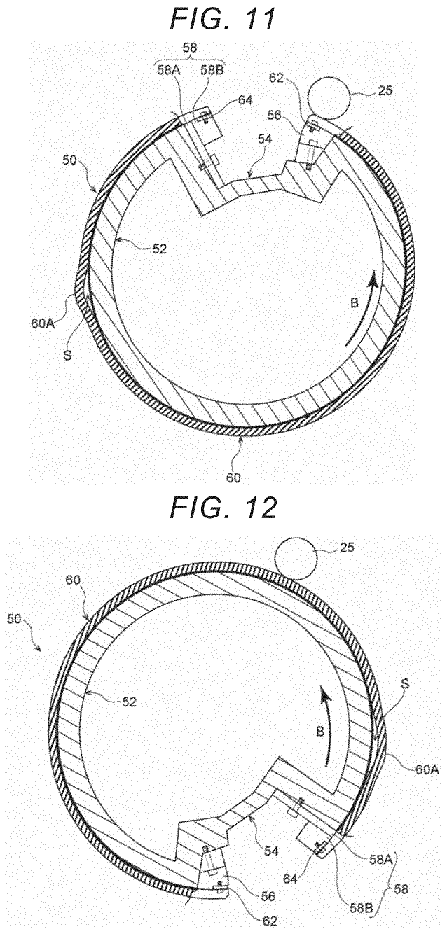

Next, a method for manufacturing the transfer cylinder 50 illustrated in FIGS. 11 to 13 will be described. The manufacturing method covers a case where the transfer member 60 is replaced with a new one.

As illustrated in FIG. 11, if the transfer member 60 is simply wound around the transfer cylindrical body 52, a gap S may be formed between the outer peripheral surface of the transfer cylindrical body 52 and the inner peripheral surface of the transfer member 60. In other words, there is a risk that a part 60A of the transfer member 60 is lifted up with respect to the transfer cylindrical body 52.

Therefore, the transfer member 60 is wound around the transfer cylindrical body 52 while being squeezed using a pressure roller 25 (an example of a pressing member). Specifically, first, the transfer cylindrical body 52 is pulled out from the body of the image forming apparatus 10 (pulling step). Then, the one end portion, in the circumferential direction, of the transfer member 60 is fixed to one end portion, in the circumferential direction, of the recess 54 of the transfer cylindrical body 52 (fixing step). That is, the first fixing member 62 is fixed to the first fixed member 56 with the fixing screw 74.

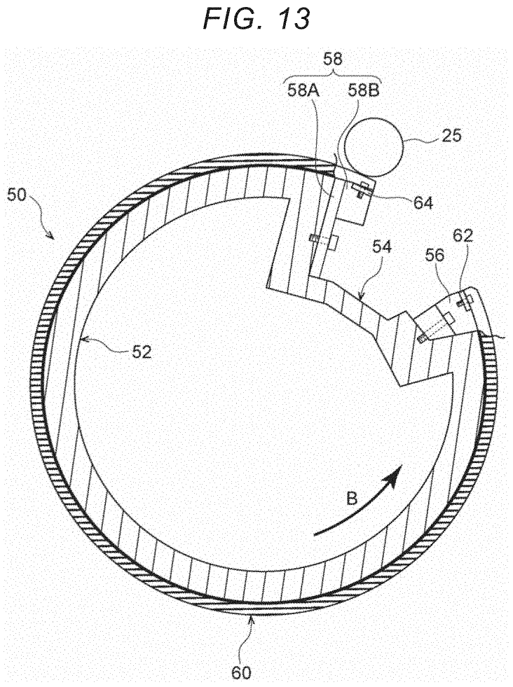

Next, as illustrated in FIG. 12, the transfer member 60 is wound around the transfer cylindrical body 52 while the outer peripheral surface of the transfer member 60 is pressed (squeezed) from the one end portion thereof to the other end portion thereof in the circumferential direction using the pressure roller 25 disposed outside the body of the image forming apparatus 10 at a pressure higher than a pressing force of the opposing roller 24 which is an example of a rotating member (winding step). As a result, the gap S gradually moves toward the other end portion of the transfer member 60 in the circumferential direction.

The one end portion, in the circumferential direction, of the outer peripheral surface of the transfer member 60, at which pressing with the pressure roller 25 starts, may be a portion separated from the one end of the outer peripheral surface of the transfer member 60 by about several centimeters to several tens of centimeters. Similarly, the other end portion, in the circumferential direction, of the outer peripheral surface of the transfer member 60, at which pressing with the pressure roller 25 ends, may be a portion separated from the other end of the outer peripheral surface of the transfer member 60 by about several centimeters to several tens of centimeters.

The “pressure higher than the pressing force of the opposing roller 24” is determined based on a penetration depth by which the pressure roller 25 penetrates into the transfer member 60 (an amount by which the transfer member 60 is collapsed along the radial direction). Specifically, the penetration depth by which the opposing roller 24 (the opposing roller 24 via the transfer belt 30) penetrates into the transfer member 60 of the transfer cylinder 50 is 1.0 mm or more and 2.0 mm or less, whereas the penetration depth by which the pressure roller 25 penetrates into the transfer member 60 of the transfer cylinder 50 is about 1.5 mm or more to about 2.5 mm or less. That is, the pressure roller 25 squeezes the transfer member 60 with a pressure at which the pressure roller 25 more penetrates into the transfer member 60 than the opposing roller 24 by about 0.5 mm or more and about 1.5 mm or less.

As illustrated in FIG. 13, finally, the other end portion (the second fixing member 64) of the transfer member 60 in the circumferential direction is pulled in the circumferential direction (in a direction away from the plate member 58A) by the biasing force of the compression spring 68. As a result, the gap S formed between the outer peripheral surface of the transfer cylindrical body 52 and the inner peripheral surface of the transfer member 60 is eliminated.

Next, an effect of the method for manufacturing the transfer cylinder 50 according to the present exemplary embodiment will be described.

As illustrated in FIGS. 11 to 13, the transfer member 60 whose one end portion (the first fixing member 62) in the circumferential direction is fixed to the transfer cylindrical body 52 is wound around the transfer cylindrical body 52 while being pressed (squeezed) from the one end portion in the circumferential direction to the other end portion in the circumferential direction using the pressure roller 25 provided outside the body of the image forming apparatus 10 at a pressure higher than the pressing force of the opposing roller 24.

Therefore, as compared to a case where the transfer member 60 is wound (i) without a pressure applied to the transfer cylindrical body 52 or (ii) with a pressure equal to or lower than the pressing force of the opposing roller 24, the transfer member 60 is prevented from being displaced with respect to the transfer cylindrical body 52 in the circumferential direction (the transfer member 60 is less likely to be displaced with respect to the transfer cylindrical body 52 in the circumferential direction) when the transfer cylinder 50 rotates while being pressed against the opposing roller 24 via the transfer belt 30.

That is, the part 60A of the transfer member 60 is prevented from being lifted up with respect to the transfer cylindrical body 52 (the gap S is prevented from being generated between the outer peripheral surface of the transfer cylindrical body 52 and the inner peripheral surface of the transfer member 60). As a result, when the transfer cylinder 50 transports the recording medium P, the occurrence of transport failure is reduced or prevented. As a result, an occurrence of image defects is reduced or prevented.

Before the fixing step, the transfer cylindrical body 52 is pulled out from the body of the image forming apparatus 10, and the winding step is performed using the pressure roller 25 disposed outside the body of the image forming apparatus 10. Therefore, as compared to a case where the winding step is performed using the opposing roller 24 as a pressure roller while the transfer cylindrical body 52 is disposed inside the body of the image forming apparatus 10, in the fixing step, it is easy to perform an operation of fixing the one end portion of the transfer member 60 in the circumferential direction with the fixing screws 74.

Instead of pulling out the transfer cylindrical body 52 from the body of the image forming apparatus 10, the winding step may be performed using, as the pressure roller, the opposing roller 24 that is in contact with the transfer member 60 via the transfer belt 30 with rotating inside the body of the image forming apparatus 10 while the transfer cylindrical body 52 is still disposed inside the body of the image forming apparatus 10. In this case, if a position of the opposing roller 24 is changeable, the pressing force of the opposing roller 24 against the transfer cylindrical body 52 can be changed.

In this case, instead of the fixing screws 74, the one end portion of the transfer member 60 in the circumferential direction (the first fixing member 62) may be fixed to the transfer cylindrical body 52 with a double-sided tape or the like. With such a configuration, it is possible to omit the pulling step of pulling out the transfer cylindrical body 52 from the body of the image forming apparatus 10, as compared to a case in which the transfer cylindrical body 52 is pulled out from the body of the image forming apparatus 10, and the winding step is performed using the pressure roller 25 disposed outside the body of the image forming apparatus 10.

The transfer member 60 that is replaceable with respect to the transfer cylindrical body 52 may be distributed in a state in which the first fixing member 62 and the second fixing member 64 are joined to the transfer member 60 in advance. With this configuration, it is possible for an operator to attach the transfer member 60 to the transfer cylindrical body 52 in fewer steps than when the first fixing member 62 and the second fixing member 64 are distributed in a state of being separated from the transfer member 60.

### Another Image Forming Apparatus

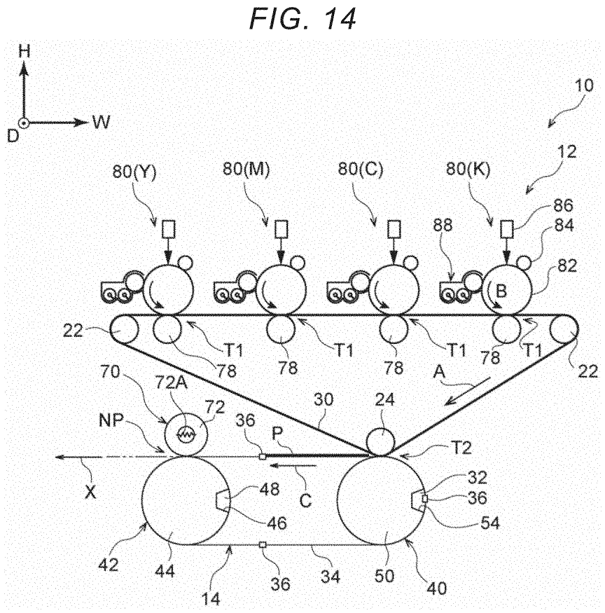

The image forming apparatus 10 according to the present exemplary embodiment is not limited to the inkjet image forming apparatus described above, but may be an electrophotographic image forming apparatus as illustrated in FIG. 14, for example. That is, instead of the adhesive layer forming device 26, the particle supply device 18, and the ejection heads 20, toner image forming units 80 that form toner images (an example of an image) of respective colors may be provided.

Each of the toner image forming units 80 (80Y, 80M, 80C, 80K) of the respective colors has a columnar photoconductor 82 that rotates in one direction (in a direction indicated by an arrow B). Around each photoconductor 82, a charging unit 84, an exposure device 86, and a developing device 88 are arranged in order from an upstream side in a rotation direction of the photoconductor 82.

In the toner image forming unit 80 of each color, the charging unit 84 charges a surface of the photoconductor 82, and the exposure device 86 exposes the surface of the photoconductor 82 charged by the charging unit 84 so as to form an electrostatic latent image on the surface of the photoconductor 82. Then, the developing device 88 develops the electrostatic latent image, which has been formed on the surface of the photoconductor 82 by the exposure device 86, so as to form a toner image.

Primary transfer rollers 78 are provided on an inner peripheral surface side of the transfer belt 30. Each primary transfer roller 78 is opposite to a respective one of the photoconductors 82 across the transfer belt 30. The toner images formed by the toner image forming units 80 of the respective colors are successively primarily transferred to and superimposed on the transfer belt 30 at primary transfer positions T1 in which the primary transfer rollers 78 are provided. The superimposed toner images are secondarily transferred to a recording medium P at a secondary transfer position T2.

The method for manufacturing the transfer cylinder 50 (the example of the cylindrical member), the transfer cylinder 50 (the example of the cylindrical member), and the image forming apparatus 10 according to the present exemplary embodiment have been described with reference to the accompanying drawings. It is noted that the method for manufacturing the transfer cylinder 50, the transfer cylinder 50, and the image forming apparatus 10 according to the present exemplary embodiment are not limited to those illustrated in the drawings. The method for manufacturing the transfer cylinder 50, the transfer cylinder 50, and the image forming apparatus 10 may be changed or modified without departing from the scope of the gist of the present disclosure. For example, the transfer member 60 is not limited to the two-layer structure, but may have a three-layer structure or a structure having more than three layers.

The transfer cylindrical body 52 may be formed in a substantially columnar shape, rather than the substantially cylinder shape. The cylindrical member is not limited to the transfer cylinder 50, but may be, for example, a fixing cylinder that pressurizes a toner image so as to fix the toner image or a blanket cylinder for use in offset printing. The manufacturing method according to the present exemplary embodiment is also applicable to such cylindrical members.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A method for manufacturing a cylindrical member, the method comprising:
fixing an end portion of an elastic body to an end portion, in a circumferential direction, of a recess provided in a cylindrical body having a substantially circular shape in cross section, the recess extending along an axial direction of the cylindrical body; and
winding the elastic body around the cylindrical body while pressing the elastic body using a pressing member.

2. The method according to claim 1, wherein
in the winding, the pressing member presses the elastic body at a pressure higher than a pressing force of a rotating member that is in contact with the elastic body while rotating inside an apparatus body.

3. The method according to claim 1, further comprising:
pulling out the cylindrical body from an apparatus body before the fixing, wherein
the winding is performed using the pressing member which is disposed outside the apparatus body.

4. The method according to claim 2, further comprising:
pulling out the cylindrical body from the apparatus body before the fixing, wherein
the winding is performed using the pressing member which is disposed outside the apparatus body.

5. The method according to claim 2, wherein
the winding is performed using the rotating member as the pressing member while the cylindrical body is still disposed inside the apparatus body.

6. A cylindrical member comprising:
a cylindrical body having a substantially circular shape in cross section, the cylindrical body having a recess along an axial direction thereof; and
an elastic body wound around and fixed to the cylindrical body by the method according to claim 1.

7. A cylindrical member comprising:
a cylindrical body having a substantially circular shape in cross section, the cylindrical body having a recess along an axial direction thereof; and
an elastic body wound around and fixed to the cylindrical body by the method according to claim 2.

8. A cylindrical member comprising:
a cylindrical body having a substantially circular shape in cross section, the cylindrical body having a recess along an axial direction thereof; and
an elastic body wound around and fixed to the cylindrical body by the method according to claim 3.

9. A cylindrical member comprising:
a cylindrical body having a substantially circular shape in cross section, the cylindrical body having a recess along an axial direction thereof; and
an elastic body wound around and fixed to the cylindrical body by the method according to claim 4.

10. A cylindrical member comprising:
a cylindrical body having a substantially circular shape in cross section, the cylindrical body having a recess along an axial direction thereof; and
an elastic body wound around and fixed to the cylindrical body by the method according to claim 5.

11. An image forming apparatus comprising:
the cylindrical member according to claim 6, the cylindrical member being configured to transport a recording medium; and
an image forming unit configured to form an image on the recording medium transported by the cylindrical member.

12. An image forming apparatus comprising:
the cylindrical member according to claim 7, the cylindrical member being configured to transport a recording medium; and
an image forming unit configured to form an image on the recording medium transported by the cylindrical member.

13. An image forming apparatus comprising:
the cylindrical member according to claim 8, the cylindrical member being configured to transport a recording medium; and
an image forming unit configured to form an image on the recording medium transported by the cylindrical member.

14. An image forming apparatus comprising:
the cylindrical member according to claim 9, the cylindrical member being configured to transport a recording medium; and
an image forming unit configured to form an image on the recording medium transported by the cylindrical member.

15. An image forming apparatus comprising:
the cylindrical member according to claim 10, the cylindrical member being configured to transport a recording medium; and
an image forming unit configured to form an image on the recording medium transported by the cylindrical member.

16. A cylindrical member comprising:
a cylindrical body having a substantially circular shape in cross section, the cylindrical body having a recess along an axial direction thereof; and
an elastic body, wherein
one end portion of the elastic body is fixed to one end portion of the recess in a circumferential direction, and
while the elastic body is pressed by a pressing member, the elastic body is wound around the cylindrical body, and the other end portion of the elastic body is fixed to the other end portion of the recess in the circumferential direction.
